(19) United States
(12) Patent Application Publication
(10) Pub. No.: US 2016/0048839 A1
(43) Pub. Date: Feb. 18, 2016

(54) SYSTEM AND METHOD FOR EXCLUSION-BASED IMPOSTER SCREENING

(71) Applicant: Michael A. Cherry, Falls Church, VA (US)

(72) Inventor: Michael A. Cherry, Falls Church, VA (US)

(21) Appl. No.: 14/465,171

(22) Filed: Aug. 21, 2014

Related U.S. Application Data
(63) Continuation-in-part of application No. 14/458,034, filed on Aug. 12, 2014.

(51) Int. Cl. G06Q 20/40; G06Q 20/34

(52) U.S. Cl. CPC G06Q 20/40145; G06Q 20/34

(57) ABSTRACT

A method for exclusion-based imposter screening is provided. The method includes obtaining a plurality of biometrics related to a payment card owner, wherein the payment card owners owns a payment card. The method also includes, during at least one transaction offer involving the payment card at a point of sale terminal of a seller, obtaining a plurality of biometrics related to a customer entering into the at least one transaction offer. The method also includes comparing the plurality of biometrics related to the payment card owner to the plurality of biometrics related to the customer. The method also includes excluding the customer from the at least one transaction offer if it is determined that the plurality of biometrics related to the customer and the plurality of biometrics related to the payment card owner cannot be from a single person.

### CROSS-REFERENCE TO RELATED APPLICATIONS

The present disclosure is a continuation in part of and claims priority to U.S. patent application Ser. No. 14/458,034 filed Aug. 12, 2014 and having the title “SYSTEM AND METHOD FOR EXCLUSION-BASED IMPOSTER SCREENING,” which is herein incorporated by reference.

### TECHNICAL FIELD

The present disclosure generally relates to imposter detection and, more particularly, to a system and method for exclusion-based imposter screening.

### DESCRIPTION OF THE RELATED ART

Identity theft and identity fraud are terms used to refer to types of crime in which someone wrongfully obtains and uses another individual's personal data in a way that involves fraud or deception, typically for economic gain. Unlike biometric identifying traits (such as fingerprints), which are unique to an individual and cannot be transferred to someone else for their use, personal data—especially Social Security numbers, bank account or credit card numbers, telephone calling card numbers, and other valuable identifying data—can be used by an imposter to personally profit at the victim's expense.

Unauthorized persons may take funds out of others' bank or financial accounts, charge purchases to others' credit card accounts, secure loans using others' identities, or take over their identities altogether, running up debts and committing crimes while using the victims' names. A victim's losses may include not only out-of-pocket financial losses, but additional costs associated with trying to restore his reputation in the community and correcting erroneous information about his financial or personal status.

Identity thieves can obtain the personal information of another person in a variety of ways: by going through trash cans and dumpsters, stealing bills and documents that have sensitive information; by stealing personal information on the job at businesses, medical offices, or government agencies; by misusing the name of a legitimate business, and calling or sending emails that trick persons into revealing personal information; by pretending to offer a job, a loan, or an apartment, and asking persons to send personal information to “qualify”; or by stealing a person's wallet, purse, backpack, or mail, and removing credit cards, driver's license, passport, health insurance card, and other items that show personal information, to name just a few non-limiting examples.

Criminals continue to find new opportunities to exploit their victims through the lack of security measures for protecting personal identifying information. Personal data is widely scattered with much of it outside an individual's control. Nationwide databases, information technology (IT) security issues, and continuous requests for Social Security numbers only add to the vulnerability of personal information. Consumers now fear that the question isn't “Will I become a victim?” but “When will I become a victim?”

According to a 2010 Bureau of Justice Statistics report, in 2007, 7.9 million households, or about 6.6 percent of all households in the United States, discovered that at least one member had been a victim of one or more types of identity theft. The number of households with at least one member who experienced one or more types of identity theft increased 23 percent from 2005 to 2007. From 2005 to 2007, the number of households that experienced credit card theft increased by 31 percent and the number that experienced multiple types during the same episode increased by 37 percent. During the 6-month period in 2008 for which identity theft victimization data was collected as part of the regular National Crime Victimization Survey, 3.3 percent of households discovered that at least one member had been a victim of one or more types of identity theft. While the Internet has helped to disseminate information about identity theft and how individuals may avoid victimization, it has also made it easier for criminals to obtain sensitive information about other persons' identities. Legislation has struggled to keep pace with the expanding avenues that criminals are exploiting, such as the Internet.

One approach to the problem of reducing the threat of identity theft is the widespread adoption of systems of biometric identification. Biometric identification systems are automated methods of recognizing a person based on one or more physical characteristics, such as fingerprints, retinas, voice, or facial characteristics. Computer-based pattern matching is at the core of all biometric systems. The technologies available are subject to varying degrees of error, which means that there is an element of uncertainty in any match.

According to the Electronic Privacy Information Center (EPIC), a public interest research organization based in Washington, D.C., the problem of identity theft cannot be solved by widespread adoption of biometric identifiers. While there are currently over 20,000 military, government and commercial installations using some form of biometric identification, those installations are specific applications within small, controlled communities. To create a nationwide network of biometric identification would be a huge undertaking, requiring vast amounts of storage and hundreds of millions of dollars.

Biometric identification answers the question, “who am IT” A person provides a sample biometric, sometimes without his or her knowledge, and the system must compare that sample to every stored record to attempt to return a match. This is known as a one-to-many match, and is done without any corroborating data. Because the matching process is based on the closeness of the new sample to a stored sample, most systems return a likely list of matches. Others return a single match if the sample is similar enough. The time for the result depends on the size of the database. For example, the FBI's Integrated Automated Fingerprint Identification System (IAFIS), which has cost several hundreds of millions of dollars to develop and which is used to identify criminals, can perform over 100,000 comparisons per second, usually completing an identification in 15 minutes with a database of over 42 million records. If identification must be done on a wide-scale basis, the number of comparisons that will need to be done simultaneously will be astronomical. In addition, consumers will likely be unwilling to wait more than a few seconds to be able to use their bank ATMs or on-line service.

Biometric authentication answers the question, “am I who I say I am?” A person presents a biometric sample, and some additional identifying data, such as a password, which is then compared to the stored sample for that person. If the person is not an imposter, the two samples should match. This is known as a one-to-one match. If a non-match occurs, some systems retake up to three samples from the person to find a best match. This is the simplest task of a biometric system because the independent identifiers help to corroborate the individual. The biometric acts as a secondary password to protect the individual.

While some biometric systems are accurate and superficially appear to be well-suited for use to prevent use of stolen personal information, the biometric systems in use now are successful because the number of people enrolled is limited. When the system fails, human administrators are available to assist in the authentication process. Creating an automated system on a national scale is beyond the capability of any of the existing technologies. Simply by merging the existing systems into a single central database would cause the reliability of those systems to be lost.

A need therefore remains for systems and methodologies that can be used to prevent use of stolen personal information. The presently disclosed embodiments are directed toward solving this need.

### SUMMARY OF THE DISCLOSED EMBODIMENTS

In one embodiment, a method for exclusion-based imposter screening is provided. The method includes obtaining a plurality of biometrics related to a payment card owner, wherein the payment card owners owns a payment card. The method also includes, during at least one transaction offer involving the payment card at a point of sale terminal of a seller, obtaining a plurality of biometrics related to a customer entering into the at least one transaction offer. The method also includes comparing the plurality of biometrics related to the payment card owner to the plurality of biometrics related to the customer. The method also includes using the point of sale terminal to initiate a payment transfer from a first account associated with the payment card to a second account associated with the seller if it is not determined that the plurality of biometrics related to the customer and the plurality of biometrics related to the payment card owner cannot be from a single person. The method also includes excluding the customer from the at least one transaction offer if it is determined that the plurality of biometrics related to the customer and the plurality of biometrics related to the payment card owner cannot be from a single person.

In another embodiment, a method for exclusion-based imposter screening is provided. The method includes obtaining a plurality of biometrics related to a payment card owner when at least one of the payment card owner registers the plurality of biometrics related to the payment card owner, the payment card owner enters into a first transaction using a payment card owned by the payment card owner, or a trigger event occurs. The method also includes during at least one transaction offer involving the payment card at a point of sale terminal of a seller, obtaining a plurality of biometrics related to a customer entering into the at least one transaction offer. The method also includes comparing at least a portion of the plurality of biometrics related to the payment card owner to at least a portion of the plurality of biometrics related to the customer. The method also includes using the point of sale terminal to initiate a payment transfer from a first account associated with the payment card to a second account associated with the seller if it is not determined that the plurality of biometrics related to the customer and the plurality of biometrics related to the payment card owner cannot be from a single person. The method also includes excluding the customer from the at least one transaction offer if it is determined that the plurality of biometrics related to the customer and the plurality of biometrics related to the payment card owner cannot be from a single person.

Other embodiments are also disclosed.

### BRIEF DESCRIPTION OF THE DRAWINGS

FIG. 1 is a schematic block diagram of a system according to an embodiment.

FIG. 2 is a schematic flow diagram of a method according to an embodiment.

FIG. 3 is a schematic flow diagram of a method according to an embodiment.

FIG. 4 is a schematic flow diagram of a method according to an embodiment.

FIG. 5 is a schematic flow diagram of a method according to an embodiment.

### DETAILED DESCRIPTION OF THE VARIOUS EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The presently disclosed embodiments comprise systems and methods that use exclusion-based imposter screening during any type of transaction in order to prevent use of one person's personal information by another person. The presently disclosed embodiments, some of which may include biometric aspects, do not rely on biometric identification or biometric authentication. Instead, the various embodiments utilize an exclusion-based methodology that relies on simple question-answer pairs and easily-obtained biometric data. These question-answer pairs and easily-obtained biometric data are used in real time during a transaction, not to authenticate this person as being the person they claim to be, but rather for “exclusionary biometrics”, defined herein to include any process to potentially exclude this person as not being the person they claim to be without biometrically identifying or authenticating the party to the transaction.

As one example of a transaction during which the presently disclosed embodiments might be used, suppose that a customer is in the checkout line at a supermarket and wishes to pay for their purchases using a credit card or other type of non-physical currency payment (collectively referred to herein as “payment card” even if no physical card is used). It would be desirable to check whether the person offering the payment card as payment can be determined not to be the payment card's owner (i.e., imposter screening) in order to provide a measure of protection against theft of personal information. However, it is desirable that any such check not be time consuming enough that it creates undue delays in the checkout process. Any such check should also not be so intrusive that a negative impression is created in the customer.

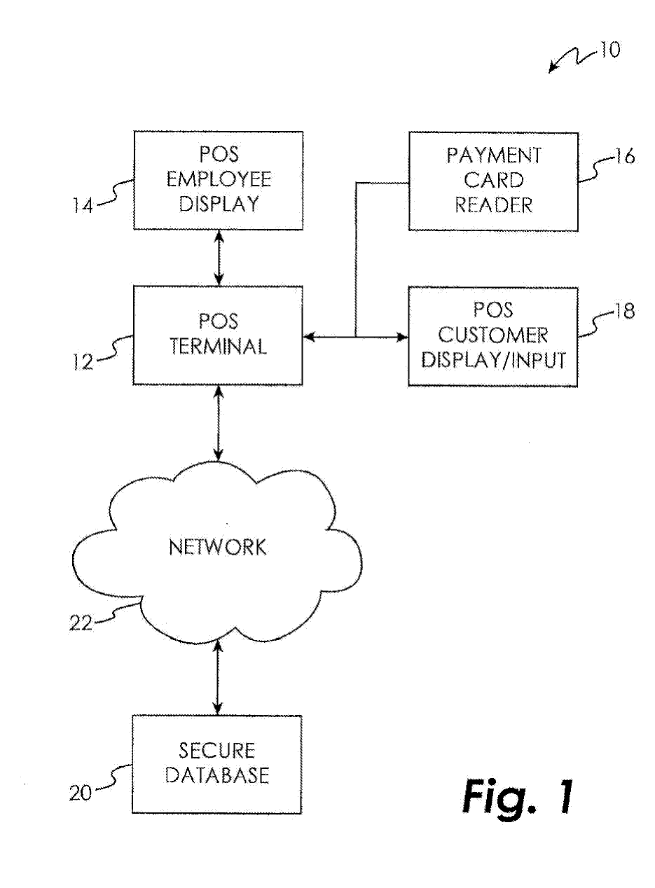

In one embodiment, the system illustrated in FIG. 1 and indicated generally at 10 may be used to perform such imposter screening using exclusionary biometrics. The system 10 includes a point of sale (POS) terminal 12, such as a cash register terminal, to name just one non-limiting example. The POS terminal 12 may have an associated employee display 14 to allow the POS terminal 12 to display information to an employee, such as a cashier. It will be appreciated that in some embodiments the POS terminal 12 and employee display 14 are integrated as one device. Depending upon the configuration, the employee is able to input data using either the POS terminal 12, the employee display 14 (by, for example, a touch sensitive screen, mouse input, or any other desired means), or a combination of the two.

Also connected to the POS terminal 12 is a payment card reader 16 which is operative to read information from a customer's offered payment card, such as customer name, account number, etc. Such reading of information may be by any convenient means, such as magnetic strip, embedded electronic memory device (so-call “smart card” technology), radio frequency identification (RFID) device, or any other desired means. Once information is read from a payment card by the payment card reader 16, this information is transmitted to the POS terminal 12.

The system 10 may also include on optional customer display/input device 18. The customer display/input device 18 is coupled to the POS terminal 12 for data interchange therewith, and may be used to display information to the customer and accept input from the customer, as discussed in greater detail hereinbelow. In some embodiments, the payment card reader 16 and customer display/input device 18 may be integrated into a single device.

The POS terminal 12 is coupled to a secure database 20. In some embodiments, the POS terminal 12 is coupled directly to the secure database 20. In some embodiments, the POS terminal 12 is coupled to the secure database 20 through a network 22. In at least one embodiment of the present disclosure, POS terminal 12 is configured to send data to and receive data from the secure database 20 through the network 22. In such an embodiment, the POS terminal 12 may engage in bidirectional communication with the secure database 20 through the network 22, such as, for example, through TCP/IP networking. In at least one embodiment of the present disclosure, the network 22 includes the Internet, but this is not required.

Coupling the POS terminal 12 to a remotely located secure database 20 allows the secure database 20 to serve multiple POS terminals 12 located at multiple unrelated businesses. For example, the entity maintaining the secure database 20 may allow access thereto to multiple businesses for a fee. In another example, the secure database 20 may be maintained by the issuer of the payment card and access to the secure database 20 may be provided to each retailer accepting such payment cards for payment. Remotely locating the secure database 20 also allows for greater security of the data stored within the secure database 20. Any unauthorized access to the supermarket computer system (e.g., by so-called “hacking”) will not expose the information maintained on the secure database 20.

Secure database 20 may reside on a server or computing device. Such server may comprise one or more server computers, computing devices, or systems of a type known in the art. Such server further comprises such software, hardware, and componentry as would occur to one of skill in the art, such as, for example, microprocessors, memory systems, input/output devices, device controllers, display systems, and the like. Such server may comprise one of many well-known servers, such as, for example, IBM's AS/400 Server, IBM's AIX UNIX Server, or MICROSOFT's WINDOWS NT Server. Such server may comprise a plurality of servers or other computing devices or systems interconnected by hardware and software systems know in the art which collectively are operable to perform the functions allocated to such server in accordance with the present disclosure.

For purposes of clarity, database 20 is shown in FIG. 1, and referred to herein as a single database. It will be appreciated by those of ordinary skill in the art that secure database 20 may comprise a plurality of databases connected by software systems of a type well known in the art, which collectively are operable to perform the functions delegated to secure database 20 according to the present disclosure. Secure database 20 may comprise a relational database architecture or other database architecture of a type known in the database art. Secure database 20 may comprise one of many well-known database management systems, such as, for example, MICROSOFT's SQL Server, MICROSOFT's ACCESS, or IBM's DB2 database management systems, or the database management systems available from ORACLE or SYBASE. Secure database 20 retrievably stores information or documents that are communicated to secure database 20 from POS terminal 12 or through network 22.

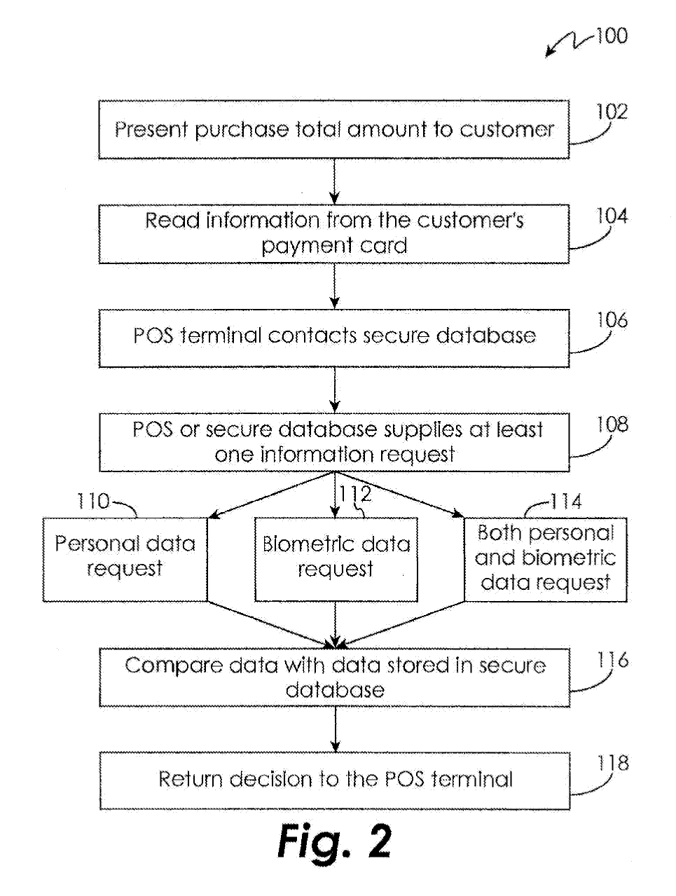

The system of FIG. 1 may be used, for example, in the supermarket checkout discussed above. The cashier operates the POS terminal 12 and has access to the employee display 14. The customer has access to the payment card reader 16 (in some embodiments, the cashier is the one provided with access to the payment card reader 16). The customer also has access to the customer display/input 18. The system 10 may be utilized to perform the security check discussed above using, for example, the embodiment method illustrated in FIG. 2 and indicated general at 100.

The method 100 begins at step 102 where the cashier presents the purchase total amount to the customer. For example, the cashier may provide input to the POS terminal that the entry of purchase information is complete, whereupon the POS terminal 12 is operative to display a purchase total amount, for example by displaying this amount on the customer display/input 18. At step 104, the customer offers a payment card as payment and the card is read by payment card reader 16. Information read from the payment card is transmitted by the payment card reader 16 to the POS terminal 12.

Upon determining that the customer is using a payment card, the POS terminal 12 may be configured to access the secure database 20 as part of the payment card authorization process at step 106. POS terminal 12 is programmed to display (at step 108) at least one information request to be used to determine if the customer can be excluded as not being the owner of the payment card. In some embodiments, the secure database 20 supplies (at step 108) the at least one information request to be used to determine if the customer can be excluded as not being the owner of the payment card. The information request corresponds to information stored within secure database 20 that is known with a degree of confidence to be correct. For example, the information request may comprise a personal data request (step 110) comprising one or more questions to be answered by the customer. Such questions may seek information that would be difficult for someone who had stolen personal information from the payment card owner to know the answer to. The following are non-limiting exemplary questions:

What is/was the color of your father's eyes?

What is your favorite sports team?

What is your favorite color?

What were the first names of both of your grandmothers?

What high school did you attend?

Where were you born?

What age were you when you graduated from undergraduate college?

How many children do you have (none, 1-3, 4-5, more than 5)

The secure database 20 contains the requested information (e.g., the answers to the questions) because this information was provided to the entity maintaining the secure database 20 by the owner of the payment card. For example, such information may be gathered as part of the application process for obtaining the payment card.

The information request may also comprise at least one biometric data request (step 112). The biometric data request may comprise data about the customer that may be used to exclude the customer by determining that the customer is not the payment card owner. For example, the biometric data request may ask the cashier to enter the approximate height of the customer standing before them. The biometric data request may ask the cashier to indicate which of three height ranges the customer falls into (under five feet tall, between five and six feet tall, or over six feet tall). The biometric data request may ask the cashier to indicate the customer's apparent age range. The biometric data request may ask the cashier to indicate the color of the customer's eyes, whether the customer is male or female, or any other biometric data that may be observed by the cashier and entered into the system so that the system may determine if the collected biometric data matches the known information stored in secure database 20.

In some embodiments, simple biometric data may be collected from the customer, such as a fingerprint scan. This biometric data is not used to positively identify that the customer is the actual owner of the payment card, but rather to exclude customers who could not be such owner (i.e., imposter screening through exclusionary biometrics). For example, the fingerprint scan data would not be used to positively identify that the customer is the payment card owner (as this may be too computationally intensive), but instead to review the data to determine if the customer may be excluded. For example, if the fingerprint data obtained from the customer comprises a loop pattern (according the Henry system of classification) and the real owner's fingerprint data comprises a whirl or arch pattern, then the customer can be excluded as not possibly being the actual owner of the payment card.

Other forms of biometric data may also be collected. By way of non-limiting example, the system 10 may ask the customer to supply answers by voice response and then determine if there is a false match on voice recognition (again, not verifying that the voice is a positive match, but instead determining if it is a non-match). It is difficult to determine a positive match due to variabilities in communication line quality, background noise, etc. But the system 10 may use much more basic comparisons, such as determining the average frequency of the speech sample, etc. Another example of biometric data collection is obtaining a photo of the customer's face and determining if gross facial features match those of the owner of the payment card, such as the ratio of the distance between the customer's eyes to the width of the customer's nose (so that scale of the photo is not a factor), gross shape of the nose, lips eyes, or other features, color of the eyes, etc.

Once the personal data and/or biometric data has been collected by the system 10, it is transmitted to the secure database 20 and compared to the corresponding data stored in secure database 20 at step 116. In some embodiments, in order to maintain the security of the data stored in secure database 20, the analysis and comparison of the collected data is performed by software resident on the server containing the secure database 20, or on another server associated therewith and under the control of the entity that maintains the secure database 20. In these embodiments, only the final determination of “exclude” or “not excluded”, or simply “accept” or “decline”, is provided to the POS terminal 12 at step 118. The secure database 20 and its optional associated servers never give out the question-answer pairs. They instead only send out the result of the comparison of the requested information and the known answer resident in the secure database 20.

In some embodiments, both personal data and biometric data is requested (step 114). In these embodiments, the system is both asking for data and measuring data, and using both forms of data to make a determination of whether the customer may be excluded as not being the true owner of the payment card.

The imposter screening systems and methods disclosed herein may be used as a security check in relation to any type of transaction. For example, if the transaction is a non-face-to-face transaction (for example a sale conducted over the telephone or the internet), biometric data may be obtained by asking the customer physical questions, such as those the cashier is asked in the supermarket example discussed hereinabove. If the non-face-to-face transaction allows for the transmission of image and/or voice information (e.g., the computer used by the customer includes a microphone and/or a camera), then biometric data may be transmitted to secure database 20 for comparison to data stored therein for imposter screening. Image and/or voice information may also be collected at other non-face-to-face transaction scenarios, such as when the customer is using an automated teller machine, to name just one non-limiting example. An automated teller machine may also be provided with the capability of obtaining a fingerprint scan from the customer to be used in the imposter screening process.

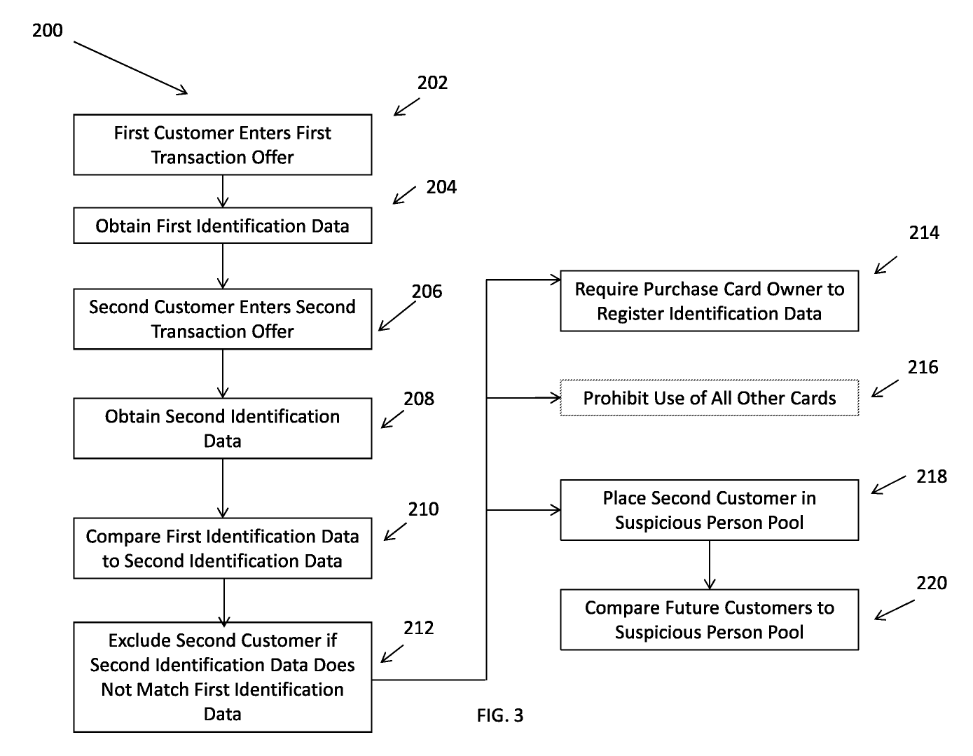

FIG. 3 illustrates another method 200 for exclusion-based imposter screening. In the embodiment shown in FIG. 3, the owner of the payment card has not pre-registered in an imposter screening process. Accordingly, the owner of the payment card has not supplied answers to any questions or biometric data to populate the database 20. Instead, in the embodiment described in FIG. 3, question answers and/or biometric data are observed when the payment card is used so that consistency upon subsequent uses of the card can be established. According to the method 200, a first customer enters into a first transaction offer at a first point of sale terminal 12, at step 202. The first transaction offer may include, for example, a face-to-face purchase, a purchase conducted over a telephone, a purchase conducted over a computer network, an automated teller machine transaction, a transaction with a bank teller, a loan application, pawning items at a pawn shop, buying items at a pawn shop, conducting business at a stock brokerage company, purchasing insurance, security screening at an airport, a car rental, purchasing gasoline, leasing real property, and/or leasing personal property, to name just a few non-limiting examples. The first transaction offer may include receiving an offer of payment from the first customer using a payment card.

At step 204, first identification data related to the first customer is obtained during the first transaction offer. The first identification data may include answers to questions and/or biometric data. Additionally, the first identification data may include more than one answer to a question and/or more than one biometric data point. Obtaining the first identification data may include entry of the identification data into the employee display 14 by the cashier. As discussed hereinabove, the cashier may note in the employee display the first customer's height, the first customer's age, the color of the first customer's eyes, the first customer's gender, the first customer's fingerprint data, the first customer's voice data, and the first customer's facial data and/or any other biometric data, which may be visualized by the cashier. Alternatively, biometric data may be captured by capturing a video and/or picture of the first customer using a camera positioned in the vicinity of the first POS terminal 12. The picture and/or video of the first customer may then be analyzed using a processor to determine biometric data related to the first customer. In at least one other embodiment, the first customer may be asked to provide a fingerprint utilizing a fingerprint scanner located at the first POS terminal 12. Alternatively, an audio recorder may be utilized to record a voice sample of the first customer. The audio recorder may be incorporated into a phone system used during over the phone sales transactions. The voice sample may then be analyzed by a processor to determine unique voice data related to the first customer. It will be appreciated that other types of biometric data may be captured. In one embodiment, the cashier may also note in the employee display, the answer to at least one question asked to obtain identification data. In at least one embodiment, any combination of the identification data described above may be obtained. The first identification data is then transmitted over the network 22 and stored in the database 20.

At step 206, a second transaction offer is entered into at a second POS terminal 12 using the same payment card used in the first transaction offer described above. The second transaction offer may be entered into using any of the methods described above. Additionally, the second POS terminal 12 may be the same POS terminal 12 as the first POS terminal 12 or may be a unique POS terminal 12 located at a distinct business. The second transaction offer is entered into by a second customer, who may or may not be the same person as the first customer. At step 208, second identification data related to the second customer is obtained. The second identification data may include answers to questions and/or biometric data. Additionally, the second information data may include more than one answer to a question and/or more than one biometric data point. The information data may be obtained using any of the methods described with relation to obtaining the first identification data.

The second identification data is compared, at step 210, to the first identification data to determine whether the second identification data and the first identification data cannot be from a single person. The second point of sale terminal is used to initiate a payment transfer from a first account associated with the payment card to a second account associated with the seller if it is not determined that the second identification data and the first identification data cannot be from a single person. At step 212, the second customer is excluded from the second transaction offer if it is determined that the second identification data and the first identification data cannot be from a single person. Additionally, if the second identification data does not match the first identification data, the owner of the purchase card is alerted and required to provide payment card owner identification data, at step 214. For example, the owner of the purchase card may be asked to personally visit a bank, credit agency, or the like to register their identification data in the database 20. Alternatively, the owner of the purchase card may be contacted by phone and/or mail and asked to provide identification data. In one embodiment, the payment card owner identification data is the same as the first identification data.

In one embodiment, when the second identification data does not match the first identification data, the system 10 prevents, at step 216, all other payment cards issued to the payment card owner from being used until the payment card owner registers their identification data in accordance with step 214. In one embodiment, the system 10 may still approve the second transaction even though the second identification data does not match the first identification data; however, the payment card owner will still be required to register identification data in accordance with step 214 before the payment card or any other payment cards issued to the payment card owner can be used again.

In another embodiment, when the second identification data does not match the first identification data, the person belonging to the second identification data, along with that person's second identification data, is placed in a suspicious person pool, at step 218. During any subsequent transaction covered by the system 10, when the identification data is collected, in addition to performing exclusionary biometrics, the system 10 and/or the sales clerk will also compare the subsequent buyer's identification data to the identification data of those in the suspicious pool to look for a match, at step 220. If there is a match, then the transaction is denied (i.e., the suspicious person is prevented from using any card because they are under suspicion). Because there are a limited number of people in the suspicious person pool, the system 10 can do the biometric identification comparisons of step 220 in substantially real time.

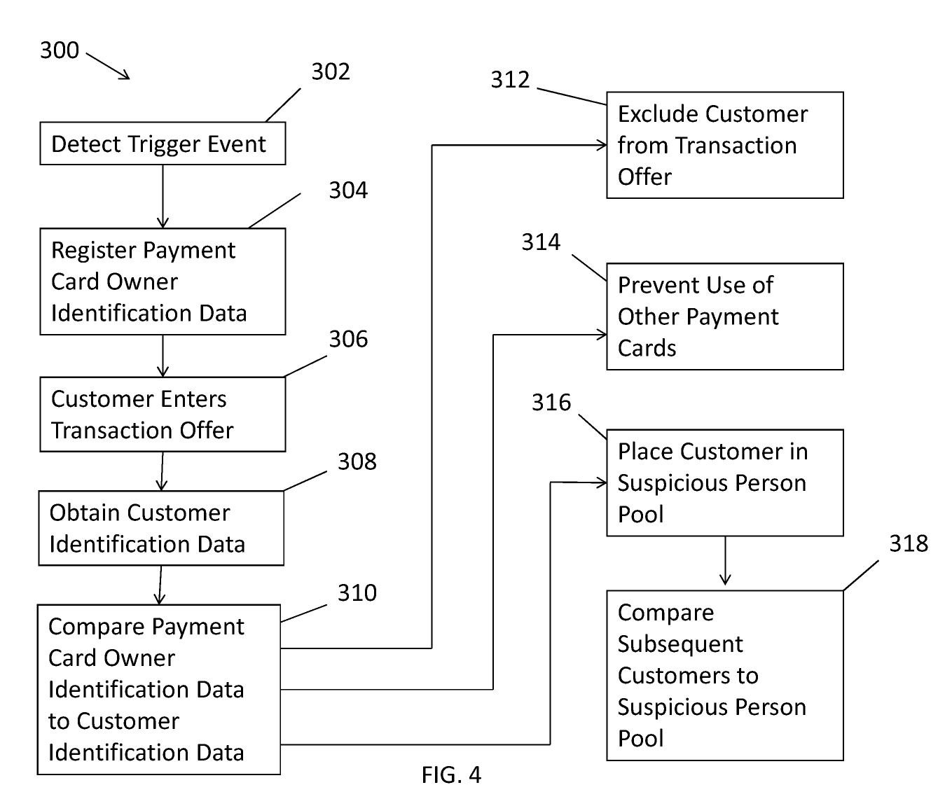

FIG. 4 illustrates another method 300 for exclusion-based imposter screening. Through method 300, the payment card owner is not required to initially register identification data. By reducing the number of individuals required to be approved by identification data at the point of sale, purchase transactions at the point of sale may be expedited and costs may be saved. However, identification data for some purchase card owners may be required when a trigger event occurs. At step 302, a trigger event necessitates the need for identification data. A trigger event may occur any time that an imposter utilizes the payment card owner's payment card. For example, an imposter may make an unauthorized transaction on the payment card. In one embodiment, such a trigger event may be detected at the time that the payment card owner reviews a bill for the payment card. An unauthorized transaction on the bill may trigger the payment card owner to report the unauthorized charge to the payment card issuer. In another example, the trigger event creating the need for identification data may be a “hack” of an organization's transaction system. For example, an imposter may illegally obtain payment card information by “hacking” a business's computer system. Any payment card owners affected by such a “hack” may be triggered to provide identification data.

At step 304, after a trigger event, the owner of the purchase card is required to provide payment card owner identification data. For example, the owner of the purchase card may be asked to personally visit a bank, credit agency, or the like to register their payment card owner identification data in the database 20. Alternatively, the owner of the purchase card may be contacted by phone and/or mail and asked to provide payment card owner identification data. The payment card owner identification data may include answers to questions and/or biometric data. Additionally, the purchase card owner information data may include more than one answer to a question and/or more than one biometric data point. The purchase card owner identification data may be obtained using any of the methods described herein in relation to obtaining identification data.

For at least one purchase transaction following the trigger event, the purchase card owner identification data is verified at the point of sale. In one embodiment, the need for verifying the purchase card owner identification data may only be required for a single transaction following the trigger event. Alternatively, the need for verifying the purchase card owner identification data may be required for a predetermined time period, for example, six months or one year, to name just two non-limiting examples. In an exemplary embodiment, the need to verify purchase card owner identification data will at some point after the trigger event be eliminated.

At step 306, after the trigger event, a transaction offer is entered into at a POS terminal 12 using the payment card. The transaction offer may be entered into using any of the methods described above. The transaction offer is entered into by a customer, who may or may not be the same person as the payment card owner. At step 308, customer identification data related to the customer is obtained. The customer identification data may include answers to questions and/or biometric data. Additionally, the customer identification data may include more than one answer to a question and/or more than one biometric data point. The customer identification data may be obtained using any of the methods described with relation to obtaining identification data.

The customer identification data is compared, at step 310, to the payment card owner identification data to determine whether the customer identification data and the payment card owner identification data cannot be from a single person. The point of sale terminal is used to initiate a payment transfer from a first account associated with the payment card to a second account associated with the seller if it is not determined that the customer identification data and the payment card owner identification data cannot be from a single person. At step 312, the customer is excluded from the transaction offer if it is determined that the customer identification data and the payment card owner identification data cannot be from a single person.

In one embodiment, when the customer identification data does not match the payment card owner identification data, the system 10 prevents, at step 314, all other payment cards issued to the payment card owner from being used until the payment card owner registers their payment card owner identification data in accordance with step 304.

In another embodiment, when the customer identification data does not match the payment card owner identification data, the person belonging to the customer identification data, along with that person's customer identification data, is placed in a suspicious person pool, at step 316. During any subsequent transaction covered by the system 10, when the identification data is collected, in addition to performing exclusionary biometrics, the system 10 and/or the sales clerk will also compare the subsequent buyer's identification data to the identification data of those in the suspicious person pool to look for a match, at step 318. If there is a match, then the transaction is denied (i.e., the suspicious person is prevented from using any card because they are under suspicion). Because there are a limited number of people in the suspicious person pool, the system 10 can do the biometric identification comparisons of step 318 in substantially real time.

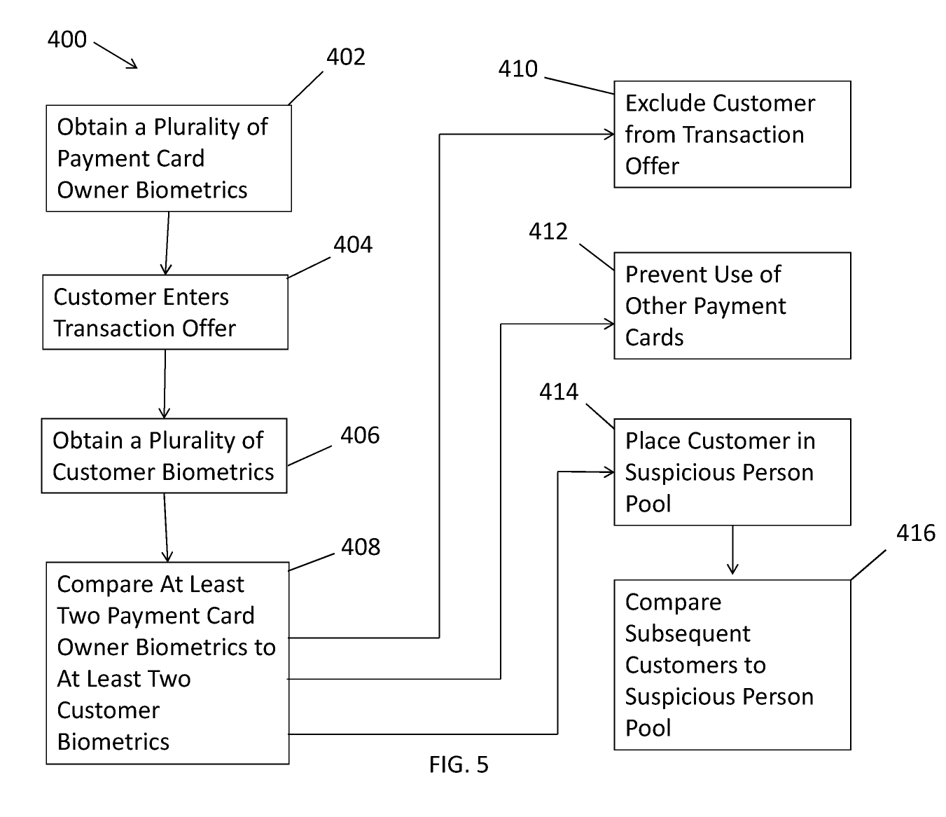

FIG. 5 illustrates another method 400 for exclusion-based imposter screening. Through method 400, a plurality of biometrics related to the payment card owner is obtained, at step 402. In one embodiment, the plurality of biometrics related to the payment card owner may be obtained when the payment card owner registers the payment card. For example, the payment card owner may be asked to personally visit a bank, credit agency, or the like to register the plurality of biometrics in the database 20. In one embodiment, the plurality of biometrics related to the payment card owner is obtained when the payment card owner enters into a transaction offer. For example, the POS terminal 12 may include a fingerprint device to record the payment card owner's fingerprints when the payment card owner swipes the payment card. Additionally, the POS terminal 12 may include a camera to record eye or facial data of the payment card owner. Moreover, the POS terminal 12 may include a recording device to record voice data of the payment card owner.

In yet another embodiment, the biometrics related to the payment card owner may be obtained after a trigger event. A trigger event may occur any time that an imposter utilizes the payment card owner's payment card. For example, an imposter may make an unauthorized transaction on the payment card. In one embodiment, such a trigger event may be detected at the time that the payment card owner reviews a bill for the payment card. An unauthorized transaction on the bill may trigger the payment card owner to report the unauthorized charge to the payment card issuer. In another example, the trigger event creating the need for identification data may be a “hack” of an organization's transaction system. For example, an imposter may illegally obtain payment card information by “hacking” a business's computer system. Any payment card owners affected by such a “hack” may be triggered to provide identification data. After a trigger event, the owner of the payment card is required to provide biometrics related to the payment card owner.

In one embodiment, the plurality of biometrics includes fingerprint data, a height, an age, eye data, gender, voice data, and facial data. The fingerprint data may include fingerprint data from all ten fingers, fingerprint data from less than ten fingers, partial fingerprint data, or the like. The eye data may include an eye shape, a partial eye shape, an iris shape, a partial iris shape, or the like. The facial data may include a facial shape, a partial facial shape, or the like.

When the biometrics are obtained after a trigger event, for at least one purchase transaction following the trigger event, the at least two of the biometrics related to the payment card owner are verified at the point of sale. In one embodiment, the at least two biometrics may include at least two partial biometrics, for example, a partial fingerprint, partial eye data, or partial facial data. In one embodiment, the need for verifying the biometrics may only be required for a single transaction following the trigger event. Alternatively, the need for verifying the biometrics may be required for a predetermined time period, for example, six months or one year, to name just two non-limiting examples. In an exemplary embodiment, the need to verify the biometrics will at some point after the trigger event be eliminated.

At step 404, a transaction offer is entered into at a POS terminal 12 using the payment card. The transaction offer may be entered into using any of the methods described above. The transaction offer is entered into by a customer, who may or may not be the same person as the payment card owner. At step 406, a plurality of biometrics related to the customer is obtained. In one embodiment, the plurality of biometrics includes fingerprint data, a height, an age, eye data, gender, voice data, and facial data. The fingerprint data may include fingerprint data from all ten fingers, fingerprint data from less than ten fingers, partial fingerprint data, or the like. The eye data may include an eye shape, a partial eye shape, an iris shape, a partial iris shape, or the like. The facial data may include a facial shape, a partial facial shape, or the like. In one embodiment, the POS terminal 12 may include a fingerprint device to record the customer's fingerprints when the customer swipes the payment card. Additionally, the POS terminal 12 may include a camera to record eye or facial data of the customer. Moreover, the POS terminal 12 may include a recording device to record voice data of the customer.

At least two of the biometrics related to the customer are compared, at step 408, to the at least two of the biometrics related to the payment card owner to determine whether the biometrics related to the customer and the biometrics related to the payment card owner cannot be from a single person. In one embodiment, only a portion of a biometric is compared, for example, a partial fingerprint, a partial eye shape, or a partial facial shape, to name a few non-limited examples. By comparing at least two biometrics, the statistical probability of matching the biometrics is reduced, thereby reducing the possibility of a false positive.

The point of sale terminal is used to initiate a payment transfer from a first account associated with the payment card to a second account associated with the seller if it is not determined that the biometrics related to the customer and the biometrics related to the payment card owner cannot be from a single person. At step 410, the customer is excluded from the transaction offer if it is determined that the biometrics related to the customer and the biometrics related to the payment card owner cannot be from a single person.

In one embodiment, when the biometrics related to the customer do not match the biometrics related to the payment card owner (i.e., it is determined that the biometrics related to the customer and the biometrics related to the payment card owner cannot be from a single person), the system 10 prevents, at step 412, all other payment cards issued to the payment card owner from being used until the payment card owner registers their biometrics with the other payment cards

In another embodiment, when the biometrics related to the customer do not match the biometrics related to the payment card owner, the person belonging to the biometrics related to the customer, along with that person's biometrics, is placed in a suspicious person pool, at step 414. During any subsequent transaction covered by the system 10, when the biometrics are collected, in addition to performing exclusionary biometrics by comparing the biometrics related to the customer and the biometrics related to the payment card owner, the system 10 and/or the sales clerk will also compare the subsequent buyer's biometrics to the biometrics of those in the suspicious person pool to look for a match, at step 416. If there is a match, then the transaction is denied (i.e., the suspicious person is prevented from using any card because they are under suspicion). Because there are a limited number of people in the suspicious person pool, the system 10 can do the biometric identification comparisons of step 416 in substantially real time.

Those skilled in the art will recognize from the present disclosure that just about any transaction can utilize the imposter screening The following is a non-limiting list of other types of transactions where imposter screening as disclosed herein can be applied: applying for a loan, conducting business with a teller at a bank, pawning items or buying items at a pawn shop, conducting business at a stock brokerage company, purchasing insurance, screening at an airport (whether for purchase or security), car rental, purchasing gasoline, leasing real or personal property, etc.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A method for exclusion-based imposter screening, comprising the steps of:
(a) obtaining a plurality of biometrics related to a payment card owner, wherein the payment card owner owns a payment card;
(b) during at least one transaction offer involving the payment card at a point of sale terminal of a seller, obtaining a plurality of biometrics related to a customer entering into the at least one transaction offer;
(c) comparing, using exclusionary biometrics, at least two of the plurality of biometrics related to the payment card owner to at least two of the plurality of biometrics related to the customer to determine if the at least two of the plurality of biometrics related to the customer and the at least two of the plurality of biometrics related to the payment card owner cannot be from a single person;
(d) using the point of sale terminal to initiate a payment transfer from a first account associated with the payment card to a second account associated with the seller if it is not determined in step (c) that the at least two of the plurality of biometrics related to the customer and the at least two of the plurality of biometrics related to the payment card owner cannot be from a single person; and
(e) excluding the customer from the at least one transaction offer if it is determined at step (c) that the at least two of the plurality of biometrics related to the customer and the at least two of the plurality of biometrics related to the payment card owner cannot be from a single person.

2. The method of claim 1, wherein the plurality of biometrics is selected from the group consisting of fingerprint data, a height, an age, eye data, gender, voice data, and facial data.

3. The method of claim 1, wherein step (c) further comprises comparing at least a portion of the plurality of biometrics related to the payment card owner to at least a portion of the plurality of biometrics related to the customer.

4. The method of claim 1, wherein step (a) occurs when the payment card owner registers the plurality of biometrics related to the payment card owner.

5. The method of claim 1, wherein step (a) occurs when the payment card owner enters into a transaction offer.

6. The method of claim 1, wherein step (a) occurs after a trigger event.

7. The method of claim 6, wherein the trigger event includes at least one of an unauthorized transaction offer entered into with the payment card or a hack of the payment card.

8. The method of claim 1 further comprising preventing all other payment cards issued to the payment card owner from being used in subsequent transactions if the plurality of biometrics related to the customer do not match the plurality of biometrics related to the payment card owner.

9. The method of claim 1 further comprising placing the customer and the plurality of biometrics related to the customer into a suspicious person pool database if the plurality of biometrics related to the customer do not match the plurality of biometrics related to the payment card owner.

10. The method of claim 9 further comprising comparing a plurality of biometrics related to subsequent customers to the plurality of biometrics related to the customer in the suspicious person pool database.

11. The method of claim 1, wherein step (a) includes entering the plurality of biometrics related to the payment card owner into a point of sale terminal.

12. The method of claim 1, wherein step (a) includes obtaining a photo of the payment card owner.

13. The method of claim 1, wherein step (a) includes obtaining a video of the payment card owner.

14. The method of claim 1, wherein step (a) includes obtaining a fingerprint of the payment card owner.

15. The method of claim 1, wherein step (a) includes obtaining a voice sample of the payment card owner.

16. The method of claim 1, wherein the transaction offer is selected from the group consisting of: a face-to-face purchase, a purchase conducted over a telephone, a purchase conducted over a computer network, an automated teller machine transaction, a transaction with a bank teller, a loan application, pawning items at a pawn shop, buying items at a pawn shop, conducting business at a stock brokerage company, purchasing insurance, security screening at an airport, a car rental, purchasing gasoline, leasing real property, and leasing personal property.

17. A method for exclusion-based imposter screening, comprising the steps of:
(a) obtaining a plurality of biometrics related to a payment card owner when at least one of the payment card owner registers the plurality of biometrics related to the payment card owner, the payment card owner enters into a first transaction using a payment card owned by the payment card owner, or a trigger event occurs;
(b) during at least one transaction offer involving the payment card at a point of sale terminal of a seller, obtaining a plurality of biometrics related to a customer entering into the at least one transaction offer;
(c) comparing, using exclusionary biometrics, at least a portion of the plurality of biometrics related to the payment card owner to at least a portion of the plurality of biometrics related to the customer to determine if the at least two of the plurality of biometrics related to the customer and the at least two of the plurality of biometrics related to the payment card owner cannot be from a single person;
(d) using the point of sale terminal to initiate a payment transfer from a first account associated with the payment card to a second account associated with the seller if it is not determined in step (c) that the plurality of biometrics related to the customer and the plurality of biometrics related to the payment card owner cannot be from a single person; and
(e) excluding the customer from the at least one transaction offer if it is determined at step (c) that the plurality of biometrics related to the customer and the plurality of biometrics related to the payment card owner cannot be from a single person.

18. The method of claim 17, wherein the plurality of biometrics is selected from the group consisting of fingerprint data, a height, an age, eye data, gender, voice data, and facial data.

19. The method of claim 17, wherein the trigger event includes at least one of an unauthorized transaction offer entered into with the payment card or a hack of the payment card.

20. The method of claim 17 further comprising preventing all other payment cards issued to the payment card owner from being used in subsequent transactions if the plurality of biometrics related to the customer do not match the plurality of biometrics related to the payment card owner.

21. The method of claim 17 further comprising:
placing the customer and the plurality of biometrics related to the customer into a suspicious person pool database if the plurality of biometrics related to the customer do not match the plurality of biometrics related to the payment card owner; and
comparing a plurality of biometrics related to subsequent customers to the plurality of biometrics related to the customer in the suspicious person pool database.

22. The method of claim 17, wherein the transaction offer is selected from the group consisting of: a face-to-face purchase, a purchase conducted over a telephone, a purchase conducted over a computer network, an automated teller machine transaction, a transaction with a bank teller, a loan application, pawning items at a pawn shop, buying items at a pawn shop, conducting business at a stock brokerage company, purchasing insurance, security screening at an airport, a car rental, purchasing gasoline, leasing real property, and leasing personal property.

23. A system for exclusion-based imposter screening, the system comprising:
a database configured to store a plurality of biometrics related to a payment card owner, wherein the payment card owner owns a payment card;
a point of sale terminal configured to obtain a plurality of biometrics related to a customer entering into at least one transaction offer at the point of sale terminal;
a server configured to compare, using exclusionary biometrics, at least two of the plurality of biometrics related to the payment card owner to at least two of the plurality of biometrics related to the customer to determine if the at least two of the plurality of biometrics related to the customer and the at least two of the plurality of biometrics related to the payment card owner cannot be from a single person;
wherein the point of sale terminal is further configured to initiate a payment transfer from a first account associated with the payment card to a second account associated with the seller if it is not determined that the at least two of the plurality of biometrics related to the customer and the at least two of the plurality of biometrics related to the payment card owner cannot be from a single person; and
wherein the point of sale terminal is further configured to exclude the customer from the at least one transaction offer if it is determined that the at least two of the plurality of biometrics related to the customer and the at least two of the plurality of biometrics related to the payment card owner cannot be from a single person.

24. The system of claim 23, wherein the plurality of biometrics is selected from the group consisting of fingerprint data, a height, an age, eye data, gender, voice data, and facial data.

25. The system of claim 23, wherein the server is further configured to compare at least a portion of the plurality of biometrics related to the payment card owner to at least a portion of the plurality of biometrics related to the customer.

26. The system of claim 23, wherein the plurality of biometrics related to the payment card owner stored in the database are registered by the payment card owner.

27. The system of claim 23, wherein the plurality of biometrics related to the payment card owner are stored in the database when at least one of the payment card owner enters into a transaction offer or after a trigger event occurs.

28. The system of claim 27, wherein the trigger event includes at least one of an unauthorized transaction offer entered into with the payment card or a hack of the payment card.

29. The system of claim 23, wherein the server is further configured to prevent all other payment cards issued to the payment card owner from being used in subsequent transactions if the plurality of biometrics related to the customer do not match the plurality of biometrics related to the payment card owner.

30. The system of claim 23, wherein the server is further configured to place the customer and the plurality of biometrics related to the customer into a suspicious person pool database if the plurality of biometrics related to the customer do not match the plurality of biometrics related to the payment card owner.

31. The system of claim 30, wherein the server is further configured to compare a plurality of biometrics related to subsequent customers to the plurality of biometrics related to the customer in the suspicious person pool database.

32. The system of claim 23, wherein the plurality of biometrics related to the payment card owner are entered into the point of sale terminal by the seller.

33. The system of claim 23, wherein the server is further configured to at least one of obtain a photo of the payment card owner, obtain a video of the payment card owner, obtain a fingerprint of the payment card owner, obtain a voice sample of the payment card owner.

34. The system of claim 23, wherein the transaction offer is selected from the group consisting of: a face-to-face purchase, a purchase conducted over a telephone, a purchase conducted over a computer network, an automated teller machine transaction, a transaction with a bank teller, a loan application, pawning items at a pawn shop, buying items at a pawn shop, conducting business at a stock brokerage company, purchasing insurance, security screening at an airport, a car rental, purchasing gasoline, leasing real property, and leasing personal property.
